(19) United States
(12) Patent Application Publication
(10) Pub. No.: US 2022/0010419 A1
(43) Pub. Date: Jan. 13, 2022

(54) MULTI-PROCESS HARDENING METHOD

(71) Applicant: KARSTEN MANUFACTURING CORPORATION, Phoenix, AZ (US)

(72) Inventor: Matthew W. Simone, Phoenix, AZ (US)

(21) Appl. No.: 17/473,814

(22) Filed: Sep. 13, 2021

Related U.S. Application Data
(63) Continuation-in-part of application No. 15/705,813, filed on Sep. 15, 2017.
(60) Provisional application No. 62/395,466, filed on Sep. 16, 2016.

(51) Int. Cl. C22F 1/18; A63B 53/04; C22C 14/00; C22F 1/00

(52) U.S. Cl. CPC C22F 1/183; A63B 53/0416; C22C 14/00; C22F 1/002; B23K 10/02; A63B 53/047; A63B 2209/00; A63B 53/0408; A63B 53/0466

(57) ABSTRACT

Embodiments of multi-process hardened golf club heads and methods of multi-process hardening of golf club heads are generally described herein. Other embodiments and methods may be described and claimed.

### CROSS-REFERENCE

This is a continuation in part of U.S. patent application Ser. No. 15/705,813, filed Sep. 15, 2017, which claims the benefit of U.S. Provisional Application No. 62/395,466, filed Sep. 16, 2016, all the contents of which are incorporated herein by reference.

### FIELD OF THE INVENTION

The present disclosure relates generally to a material hardening method, and more particularly, a material hardening method for a golf club head.

### BACKGROUND

Typically, golf club heads are manufactured to be high in hardness, yield and tensile strength to produce consistent performance after constant impact with a ball. Manufacturing high hardness, yield and tensile strengths of the golf club head can be achieved through different manufacturing processes as well as through different metal compositions. However, when increasing the hardness, yield and tensile strength of certain metal composition, it can lower the ductility of the golf club head. A low ductility golf club head is very brittle and can crack and break more easily during impact with the ball compared to golf club heads that are more ductile. Therefore there is a need in the art for a manufacturing process or processes applied to a certain material to produce a high hardness, yield and tensile strength for a golf club head while maintaining ductility.

### BRIEF DESCRIPTION OF DRAWINGS

FIG. 1 shows a perspective view of a golf club head with a faceplate.

FIG. 2 shows a perspective view of the golf club head with the faceplate removed.

FIG. 3 shows a top view of a club head assembly.

FIG. 4 shows a flow diagram of different manufacturing processes.

Other aspects of the disclosure will become apparent by consideration of the detailed description and accompanying drawings.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

### DETAILED DESCRIPTION

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements, mechanically or otherwise. Coupling (whether mechanical or otherwise) may be for any length of time, e.g., permanent or semi-permanent or only for an instant.

The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

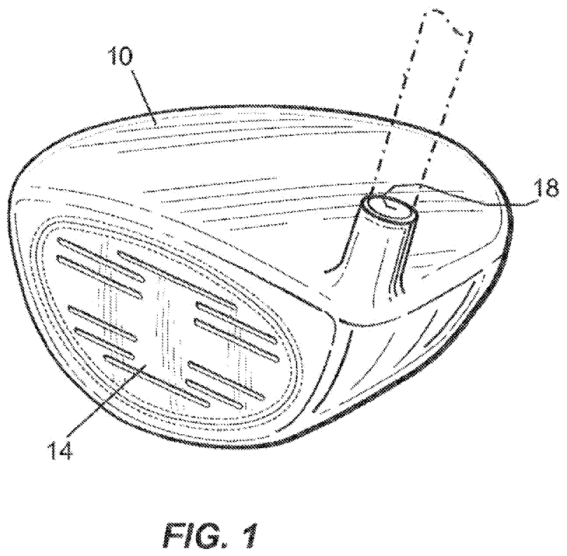

FIG. 1-3 shows a golf club head 10 and a faceplate 14. In one embodiment, the golf club head 10 is formed from a cast material and the faceplate 14 is formed from a rolled material. Further, in the illustrated embodiment, the golf club head 10 is for a metal wood driver. In other embodiments, the golf club head 10 can be a fairway wood, a hybrid, or an iron club. The golf club head 10 may further comprise a hosel 18.

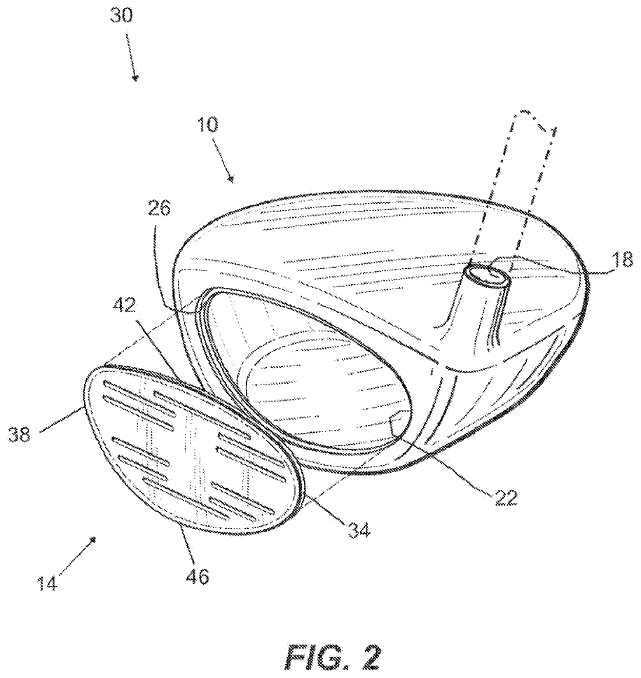

As shown in FIG. 2, the golf club head 10 further includes a recess or opening 22 for receiving the faceplate 14. In the illustrated embodiment, the opening 22 includes a lip 26 extending around the perimeter of the opening 22. The faceplate 14 is aligned with the opening and abuts the lip 26. The faceplate 14 is secured to the golf club head 10 by welding, forming a club head assembly 30. In one embodiment, the welding is a pulse plasma welding process.

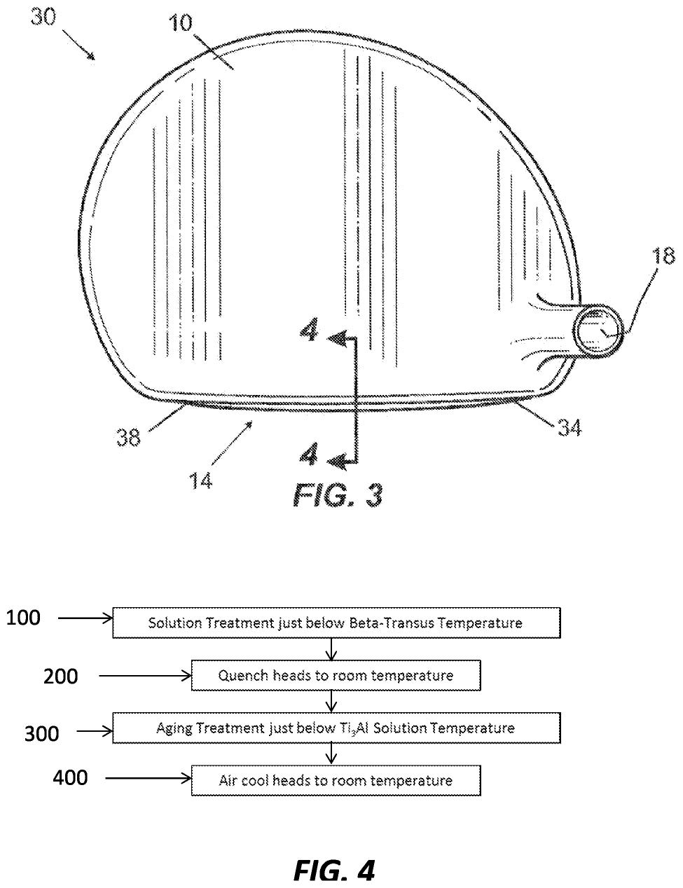

The faceplate 14 includes a heel end 34 and a toe end 38 opposite the heel end 34. The heel end 34 is positioned proximate the hosel 18. The faceplate 14 further includes a crown edge 42 and a sole edge 46 opposite the crown edge 42. The crown edge 42 is positioned adjacent an upper edge of the club head 10, while the sole edge 46 is positioned adjacent the lower edge of the golf club head 10. As shown in FIG. 3, the faceplate 14 has a bulge curvature in a direction extending between the heel end 34 and the toe end 38. In one embodiment, the faceplate may have a minimum wall thickness of 1.5 millimeters, 1.4 millimeters, 1.3 millimeters, 1.2 millimeters, 1.1 millimeters, 1.0 millimeters, 0.9 millimeters, 0.8 millimeters, 0.7 millimeters, 0.6 millimeters, 0.5 millimeters and 0.4 millimeters. In one embodiment, the faceplate may have a minimum wall thickness of 0.7 millimeters.

Described herein are combined processes, as illustrated in FIG. 4, which can be applied to optimize the properties of the club head assembly 30 during manufacturing. However, when describing these combined processes below pertaining to the club head assembly 30, the combined processes can be further applied to individual components of the faceplate 14, and the golf club head 10. The first process is a heat treat process 100 the club head assembly 30 just below the beta-transus temperature of an alpha-beta titanium (α-β Ti) alloy solution. The beta-transus temperature is the lowest temperature at which a 100-percent β phase can exist. The second process is a quenching method process 200 that strengthens and hardens the club head assembly 30. A third process is an aging treatment 300 to increase the ductility by increasing the heat to just below the transition (solvus) temperature of Ti₃Al. Following right after the aging treatment process 300, the club head assembly 30 undergoes a heat reduction process 400, back down to room temperature. The combined processes of the heat treatment process 100, the quenching method process 200, the aging treatment process 300 and the heat reduction process 400 changes the structural properties of the club head assembly 30 wherein the end product is a high hardness, high yield and high tensile strength club head assembly 30 that is not brittle. Further, having a stronger club head assembly 30 allows for a manufacturer to design the faceplate 14 to be thinner, thus allowing discretionary weight to be placed elsewhere on the golf club head 10. Redistributing discretionary weight at different locations on the club head assembly 30 may affect the center of gravity (CG) as well as moment of inertia (MOI). A thinner faceplate 14 can further produce more deflection during impact with a ball for higher trajectory and/or ideal spin.

In the current invention, the club head assembly 30 can comprise a material that is an alpha-beta titanium (α-β Ti) alloy. The faceplate 14 and the golf club head 10 can comprises the same α-β Ti alloy, or different α-β Ti alloy from one another. The α-β Ti alloy may contain neutral alloying elements such as tin and α stabilizers such as aluminum and oxygen. The α-β Ti alloy may contain β-stabilizers such as molybdenum, silicon and vanadium. All numbers described below regarding weight percent are a total weight percent (wt %). The total weight percent of α-stabilizer aluminum in α-β Ti alloy may be between 2 wt % to 10 wt %, 3 wt % to 9 wt %, 4 wt % to 8 wt %, or 5 wt % to 7 wt %. The total weight percent of α-stabilizer oxygen in α-β Ti alloy may be between 0.05 wt % to 0.35 wt %, or 0.10 wt % to 0.20 wt %. The total weight percent of β-stabilizer molybdenum in α-β Ti alloy may be between 0.2 wt % to 1.0 wt %, or 0.6 wt % to 0.8 wt %, or trace amounts. The total weight percent of β-stabilizer vanadium in α-β Ti alloy may be between 1.5 wt % to 7 wt %, or 3.5 wt % to 4.5 wt %. The total weight percent of β-stabilizer silicon in α-β Ti alloy may be between 0.01 to 0.10 wt %, or 0.03 wt % to 0.07 wt %. The α-β Ti alloy may be Ti-6Al-4V (or Ti 6-4), Ti-9S (or T-9S), Ti-662, Ti-8-1-1, Ti-65K, Ti-6246, or IMI 550. The combination of α, β stabilizers allows the α-β Ti alloys to be heat treated. Further, the microstructure of the alpha stabilizers is more ductile which gives the club head assembly 30, faceplate 14, and club head assembly 30 more elasticity. More elasticity prevents cracks and permanent deformation during impacts with the ball. Further, high ductility extends the life of the club head assembly 30. The beta microstructure works differently from the alpha microstructure. The microstructure of the beta stabilizers can be dissolved at certain temperatures and cooled to transform into different structures to increase in strength. By manipulating the α-β Ti alloy with specific processes at certain temperatures during manufacturing, the club head assembly 30 can be optimized to be high in hardness and strength while maintaining the ductility.

In one embodiment, the α-β Ti may be Ti 6-4 containing 6 wt % aluminum (Al), and 4 wt % vanadium (V), with the remaining alloy composition being titanium and possibly some trace elements. In some embodiments, Ti 6-4 contains between 5.5 wt %-6.75 wt % Al, between 3.5 wt %-4.5 wt % V, a maximum of 0.08 wt % carbon (C), a maximum of 0.03 wt % silicon (Si), a maximum of 0.3 wt % iron (Fe), a maximum of 0.2 wt % oxygen (O), a maximum of 0.015 wt % tin (Sn), and trace amounts of molybdenum (Mo), with the remaining alloy composition being titanium. In some embodiments, Ti 6-4 contains between 5.5 wt %-6.75 wt % Al, between 3.5 wt %-4.5 wt % V, 0.08 wt % or less carbon (C), 0.03 wt % or less silicon (Si), 0.3 wt % or less iron (Fe), 0.2 wt % or less oxygen (O), 0.015 wt % or less tin (Sn), and trace amounts of molybdenum (Mo), with the remaining alloy composition being titanium. Ti 6-4 is a grade 5 titanium. The solvus temperature for Ti 6-4 is between 540° C. and 560° C. In some embodiments, Ti 6-4 has a density of 0.1597 lb/in³ (4.37 g/cc). Ti-6-4 may also be designated as T-65K.

In other embodiments, the club head assembly 30 may be another α-β Ti alloy, such as Ti-9S (or T-9S), which contains 8 wt % Al, 1 wt % V, and 0.2 wt % Si, with the remaining alloy composition being titanium and possibly some trace elements. In some embodiments, Ti-9S (or T-9S) contains 6.5 wt %-8.5 wt % Al, between 1 wt %-2 wt % V, a maximum of 0.08 wt % C, a maximum of 0.2 wt % Si, a maximum of 0.3 wt % Fe, a maximum of 0.2 wt % O, a maximum of 0.05 wt % N, trace amounts of Mo, and trace amounts of Sn, with the remaining alloy composition being titanium. In some embodiments, Ti-9S (or T-9S) contains 6.5 wt %-8.5 wt % Al, between 1 wt %-2 wt % V, less than 0.1 wt % C, a maximum of 0.2 wt % Si, a maximum of 0.4 wt % Fe, a maximum of 0.15 wt % O, less than 0.05 wt % N, trace amounts of Mo, and trace amounts of Sn, with the remaining alloy composition being titanium. In some embodiments, Ti-9S (or T-9S) contains 6.5 wt %-8.5 wt % Al, between 1 wt %-2 wt % V, 0.1 wt % or less C, 0.2 wt % or less Si, 0.4 wt % or less Fe, 0.15 wt % or less O, less than 0.05 wt % N, trace amounts of Mo, and trace amounts of Sn, with the remaining alloy composition being titanium. The solvus temperature for Ti-9S (or T-9S) is between 560° C. and 590° C. In some embodiments, the Ti-9S (or T-9s) will have higher porosity and a lower yield than Ti 8-1-1. Ti-9S (or T-9S) has a density of about 0.156 lb/in³ to 0.157 lb/in³ (4.32-4.35 g/cc). Ti-9S (or T-9S) has a density of 0.156 lb/in³ (4.32 g/cc).

In other embodiments, the material may be another α-β Ti alloy, such as Ti-6-6-2, Ti-6246, or IMI 550. Titanium 662 may contain 6 wt % Al, 6 wt % V, and 2 wt % Sn, with the remaining alloy composition being titanium and possibly some trace elements. Ti-6-6-2 has a density of 0.164 lb/in3 (4.54 g/cc). The solvus temperature for Ti 6-6-2 is between 540° C. and 560° C. Titanium 6246 may contain 6 wt % Al, 2 wt % Sn, 4 wt % zirconium (Zr), and 6 wt % Mo, with the remaining alloy composition being titanium and possibly some trace elements. The solvus temperature for Ti 6246 is between 570° C. and 590° C. Ti-6246 has a density of 0.168 lb/in3 (4.65 g/cc). IMI 550 may contain 6 wt % Al, 2 wt % Sn, 4 wt % Mo, and 0.5 wt % Si, with the remaining alloy composition being titanium and possibly some trace elements. The solvus temperature for IMI 550 is between 490° C. and 510° C. IMI 550 has a density of 0.157 lb/in³ (4.60 g/cc).

In other embodiments, the material may be another α-β Ti alloy, such as Ti-8-1-1, which may contain 8 wt % Al, 1.0 wt % Mo, and 1 wt % V, with the remaining alloy composition being titanium and possibly some trace elements. In some embodiments, Ti-8-1-1 may contain 7.5 wt %-8.5 wt % Al, 0.75 wt %-1.25 wt % Mo., 0.75 wt %-1.25 wt % V, a maximum of 0.08 wt % C, a maximum of 0.3 wt % Fe, a maximum of 0.12 wt % O, a maximum of 0.05 wt % N, a maximum of 0.015 wt % H, a maximum of 0.015 wt % Sn, and trace amounts of Si, with the remaining alloy composition being titanium. The solvus temperature for Ti-8-1-1 is between 560° C. and 590° C. In some embodiments, Ti-8-1-1 has a density of 0.1580 lb/in³ (4.37 g/cc).

### A) Heat Treat Process

The first process is the heat treat process 100 the club head assembly 30 just below the beta-transus (β-transus) temperature. The club head assembly 30 can be heated within a vacuumed environment chamber pumped with inert gas. The inert gas can be selected from the group consisting of nitrogen, argon, helium, neon, krypton, and xenon, or a compound gas thereof. The club head assembly 30 can further be heated by induction heating with induction heating coils. In induction heating with induction heating coils, an alternating magnetic field penetrates a material, creating an electrical current within the material. The electrical current excites the atoms within the material resulting in a generation of heat. Induction heating also allows for stronger grain structures and stress relieves weak spots and weld areas.

Unlike heating the club head assembly 30 above the β-transus temperature, wherein all the β stabilizers dissolve within the matrix of the solution, heating the α-β Ti alloy of the club head assembly 30 just below the solvus temperature, only a portion of the β stabilizers dissolve. The remaining β stabilizers that are retained, upon cooling quickly, transform into martensite grains. Martensite is a meta-stable phase that is strong and hard which in turn and hardens and strengthens the club head assembly 30. Hardening and strengthening the golf club 10 in yield and tensile strength helps withstand the impact against the ball. Hardening and strengthening the club head assembly 30 further allows for a thinner faceplate 14. A stronger and thinner faceplate 14 can produce more deflection during impact against the ball and further, the discretionary weight of the thinner faceplate 14 can be redistributed elsewhere on the club head assembly 30. The temperature at which the club head assembly 30 is heated to is dependent on the α-β Ti alloy the club head assembly 30 comprises.

In one embodiment, the club head assembly 30 is heat treated in an α-β Ti alloy solution at a temperature at or below the β-transus temperature of the α-β Ti alloy for between 1 hour and 6 hours. In one embodiment, the club head assembly 30 is heat treated in an α-β Ti alloy solution at a temperature at or below the β-transus temperature of the α-β Ti alloy for between 1 hour and 2 hours. In one embodiment, the club head assembly 30 is heat treated in an α-β Ti alloy solution at a temperature at or below the β-transus temperature of the α-β Ti alloy for between 1 hour and 4 hours. In one embodiment, the club head assembly 30 is heat treated in an α-β Ti alloy solution at a temperature at or below the β-transus temperature of the α-β Ti alloy for between 4 hours and 6 hours. In one embodiment, the club head assembly 30 is heat treated in an α-β Ti alloy solution at a temperature at or below the β-transus temperature of the α-β Ti alloy for between 1.5 hours and 5.5 hours. In one embodiment, the club head assembly 30 is heat treated in an α-β Ti alloy solution at a temperature at or below the β-transus temperature of the α-β Ti alloy for between 2 hours and 5 hours. In one embodiment, the club head assembly 30 is heat treated in an α-β Ti alloy solution at a temperature at or below the β-transus temperature of the α-β Ti alloy for between 2.5 hours and 4.5 hours. In one embodiment, the club head assembly 30 is heat treated in an α-β Ti alloy solution at a temperature at or below the β-transus temperature of the α-β Ti alloy for between 3 hours and 4 hours.

In one embodiment, the club head assembly 30 is heat treated in an α-β Ti alloy solution at a temperature at or below the β-transus temperature of an α-β Ti alloy for at least 1 hour. In one embodiment, the club head assembly 30 is heat treated in an α-β Ti alloy solution at a temperature at or below the β-transus temperature of the α-β Ti alloy for at least 1.5 hours. In one embodiment, the club head assembly 30 is heat treated in an α-β Ti alloy solution at a temperature at or below the β-transus temperature of the α-β Ti alloy for at least 2 hours. In one embodiment, the club head assembly 30 is heat treated in an α-β Ti alloy solution at a temperature at or below the β-transus temperature of the α-β Ti alloy for at least 2.5 hours. In one embodiment, the club head assembly 30 is heat treated in an α-β Ti alloy solution at a temperature at or below the β-transus temperature of the α-β Ti alloy for at least 3 hours. In one embodiment, the club head assembly 30 is heat treated in an α-β Ti alloy solution at a temperature at or below the β-transus temperature of the α-β Ti alloy for at least 3.5 hours. In one embodiment, the club head assembly 30 is heat treated in an α-β Ti alloy solution at a temperature at or below the β-transus temperature of the α-β Ti alloy for at least 4 hours. In one embodiment, the club head assembly 30 is heat treated in an α-β Ti alloy solution at a temperature at or below the β-transus temperature of the α-β Ti alloy for at least 4.5 hours. In one embodiment, the club head assembly 30 is heat treated in an α-β Ti alloy solution at a temperature at or below the β-transus temperature of the α-β Ti alloy for at least 5 hours. In one embodiment, the club head assembly 30 is heat treated in an α-β Ti alloy solution at a temperature at or below the β-transus temperature of the α-β Ti alloy for at least 5.5 hours. In one embodiment, the club head assembly 30 is heat treated in an α-β Ti alloy solution at a temperature at or below the β-transus temperature of the α-β Ti alloy for at least 6 hours.

In one embodiment, the club head assembly 30 is heat treated in an α-β Ti alloy solution between 800° C. and 1030° C. In one embodiment, the club head assembly 30 is heat treated in an α-β Ti alloy solution between 825° C. and 950° C. In one embodiment, the club head assembly 30 is heat treated in an α-β Ti alloy solution between 850° C. and 925° C. In one embodiment, the club head assembly 30 is heat treated in an α-β Ti alloy solution between 950° C. and 1025° C. In one embodiment, the club head assembly 30 is heat treated in an α-β Ti alloy solution at 800° C., 810° C., 820° C., 830° C., 840° C., 850° C., 860° C., 870° C., 880° C., 890° C., 900° C., 910° C., 920° C., 930° C., 940° C., 950° C., 960° C., 970° C., 980° C., 990° C., 1000° C., 1010° C., 1020° C., or 1030° C. for 30 minutes, 60 minutes, 90 minutes, 120 minutes, 150 minutes, 180 minutes, 210 minutes, 240 minutes, 270 minutes, 300 minutes, 330 minutes or 360 minutes.

In one embodiment, the club head assembly 30 is heat treated in an α-β Ti alloy solution at a temperature of at least 800° C. In one embodiment, the club head assembly 30 is heat treated in an α-β Ti alloy solution at a temperature of at least 820° C. In one embodiment, the club head assembly 30 is heat treated in an α-β Ti alloy solution at a temperature of at least 840° C. In one embodiment, the club head assembly 30 is heat treated in an α-β Ti alloy solution at a temperature of at least 860° C. In one embodiment, the club head assembly 30 is heat treated in an α-β Ti alloy solution at a temperature of at least 875° C. In one embodiment, the club head assembly 30 is heat treated in an α-β Ti alloy solution at a temperature of at least 880° C. In one embodiment, the club head assembly 30 is heat treated in an α-β Ti alloy solution at a temperature of at least 900° C. In one embodiment, the club head assembly 30 is heat treated in an α-β Ti alloy solution at a temperature of at least 920° C. In one embodiment, the club head assembly 30 is heat treated in an α-β Ti alloy solution at a temperature of at least 940° C. In one embodiment, the club head assembly 30 is heat treated in an α-β Ti alloy solution at a temperature of at least 960° C. In one embodiment, the club head assembly 30 is heat in an α-β Ti alloy heat treated at a temperature of at least 975° C. In one embodiment, the club head assembly 30 is heat treated in an α-β Ti alloy solution at a temperature of at least 980° C. In one embodiment, the club head assembly 30 is heat treated in an α-β Ti alloy solution at a temperature of at least 1000° C. In one embodiment, the club head assembly 30 is heat treated in an α-β Ti alloy solution at a temperature of at least 1020° C. In one embodiment, the club head assembly 30 is heat treated in an α-β Ti alloy solution at a temperature of at least 1025° C. In one embodiment, the club head assembly 30 is heat treated in an α-β Ti alloy solution at a temperature of at least 1030° C.

### B) Quenching Method Process

The club head assembly 30 then undergoes the quenching method process 200 to reduce the heat of the club head assembly 30 in a controlled and rapid manner to room temperature. The quenching method process 200 is done by applying the heated club head assembly 30 quickly into a fluid that is at a select temperature. The quick reduction of heat during the quenching method process 200 allows for a majority of the remaining β stabilizers to transform into martensite grains, while still comprising a portion of retained β stabilizers as well as some reformed α. The martensite grains are in a meta-stable phase that is both strong and rigid, thus increasing the strength and hardness of the club head assembly 30. The increase of the strength and the hardness of the club head assembly 30 allows for the faceplate 14 to be thinner, thus having more deflection during impact with a ball. The thinness of the faceplate 14 also further allows for discretionary weight to be placed elsewhere on the club head assembly 30 to optimize the CG placement and the MOI.

The fluid used in the quenching method process 200 can be liquids or gases. The liquids comprise of straight oils, water, water soluble fluids, micro-dispersion oils, and synthetic or semi-synthetic fluids. The straight oils can comprise base minerals, petroleum oils, and polar lubricants such as fats, vegetable oils, and esters. The straight oils can further comprise of extreme pressure additives such as chlorine, sulfur, and phosphorus. The water soluble fluids are highly diluted oils that form an emulsion when mixed with water. Micro-dispersion oils comprise a dispersion of solid lubricant particles such as PTFE, graphite, and molybdenum disulfide or boron nitride in a mineral, or petroleum. Synthetic or semi-synthetic fluids are greases based on synthetic compounds like silicone, polyglycol, esters, diesters, chlorofluorocarbons (CFCs), and mixtures of synthetic fluids and water. The gases comprise inert gases such as nitrogen or all the noble gases (e.g., helium, neon, argon, krypton, xenon, and radon).

The quenching method process 200 cools the club head assembly 30 to room temperature at an extremely quick rate, known as the quenching rate. The quenching rate may determine the amount of remaining β stabilizers transform into martensite. In one embodiment, the quenching rate of the quenching method process 200 is 2000° C. per second. In other embodiments, the quenching rate can be at least 550° C. per second, at least 750° C. per second, at least 1000° C. per second, at least 1500° C. per second, at least 1700° C. per second, at least 2000° C. per second, at least 2300° C. per second, at least 2500° C. per second, at least 2700° C. per second, at least 3000° C. per second, at least 3300° C. per second, at least 3500° C. per second, at least 3700° C. per second, at least 4000° C. per second, at least 4300° C. per second, at least 4500° C. per second, at least 4700° C. per second, at least 5000° C. per second, at least 5300° C. per second, at leas 5500° C. per second, at least 5700° C. per second, at least 6000° C. per second, at least 6300° C. per second, at least 6500° C. per second, a least 6700° C. per second, at least 7000° C. per second, at least 7300° C. per second, at least 7500° C. per second, at least 7700° C. per second, or at least 8000° C. per second.

### C) Aging Treatment Process

After the remaining β stabilizers have transformed into martensite with the quenching method process 200, the club head assembly 30 then undergoes the aging treatment process 300. The aging treatment process 300 increases the temperature of the club head assembly 30 to further manipulate the structural properties of the club head assembly 30. Specifically, the aging treatment process 300 further increases the strength of the club head assembly 30 and prevents the ductility of the club head assembly 30 from decreasing too low. Further, the aging treatment process 300 can be applied to specific portions of the club head assembly 30 so that the increased structural properties are concentrated in those areas. The aging treatment process 300 can be done by convention heating by an aging oven or induction heating by induction heating coils.

In conventional heating of an aging oven, heat is transferred to the surface of a material by conduction, convection or radiation and into the interior of the material by thermal conduction. Conventional heating allows the molecular structure of the material to create a uniform structure, growing larger grain structures within the matrix of the material, elimination any weak spots, as well as stress relieving weld areas.

The temperature of the aging oven for conventional heating can be increased at an aging rate. In one embodiment, the aging rate applied to the club head assembly 30 can be 400° C. per half hour. In other embodiments, the aging rate applied can be at least 100° C. per half hour, at least 150° C. per half hour, at least 200° C. per half hour, at least 250° C. per half hour, at least 300° C. per half hour, at least 350° C. per half hour, at least 400° C. per half hour, at least 450° C. per half hour, at least 500° C. per half hour, at least 550° C. per half hour, at least 600° C. per half hour, at least 650° C. per half hour, at least 700° C. per half hour, at least 750° C. per half hour, at least 800° C. per half hour, at least 850° C. per half hour, at least 900° C. per half hour, at least 950° C. per half hour, or at least 1000° C. per half hour.

The induction heating for aging the club head assembly is similar to the induction heating of the heat treatment process 100 as described above. Similar to the temperature of the aging oven, the temperature of the induction heating coils can also be increased at an induction heating rate. In one embodiment, the induction heating applied to the club head assembly 30 can be 400° C. per half hour. In other embodiments, the induction heating rate applied can be at least 100° C. per half hour, at least 150° C. per half hour, at least 200° C. per half hour, at least 250° C. per half hour, at least 300° C. per half hour, at least 350° C. per half hour, at least 400° C. per half hour, at least 450° C. per half hour, at least 500° C. per half hour, at least 550° C. per half hour, at least 600° C. per half hour, at least 650° C. per half hour, at least 700° C. per half hour, at least 750° C. per half hour, at least 800° C. per half hour, at least 850° C. per half hour, at least 900° C. per half hour, at least 950° C. per half hour, or at least 1000° C. per half hour.

During the aging treatment process 300, the club head assembly 30 is heated to just below the transition temperature of Ti₃Al. Upon reaching just below the transition temperature of Ti₃Al, precipitates of the Ti₃Al moves into the solution matrix and settles along the grain boundaries of the α-β Ti alloy. The precipitates concentrating around the grain boundary increases the grain boundary thickness and thus increases the strength and hardness of the club head assembly 30. Since the aging treatment 300 increases the strength and the hardness of the club head assembly 30, the faceplate 14 can be manufactured with less material, thus giving the faceplate 14 more deflection during impact with a ball. A thinner faceplate 14 further allows for discretionary weight of the golf club head to be redistributed to different locations on the golf club head for optimal CG placement and MOI. The precipitates concentrating around the grain boundary further acts as a stress reliever. Stress relieving the club head assembly 30 help maintain the ductility of the club head assembly 30 which can prevent cracks and permanent deformation.

### D) Heat Reduction Process

Once the club head assembly 30 has undergone the aging process 300, the club head assembly 30 goes through the heat reduction process 400 to cool down to room temperature at a relatively slow cooling rate. The relatively slow cooling rate may help further maintain the ductility of the club head assembly 30 from decreasing to a point where the club head assembly 30 becomes brittle. The relatively slow cooling rate further reduces the chances of the club head assembly 30 from experiencing oxidation. Subjecting the club head assembly 30 to the heat reduction process 400 to room temperature can be done by slowly reducing the temperature of the induction heating coils, or aging oven from the aging treatment process 300 process above. The club head assembly 30 can be further cooled down to room temperature slowly by immersing the club head assembly 30 to ceramic materials or by convection cooling.

The club head assembly 30 being cooled down by induction heating can vastly extend the cooling time. The cooling time is completely controlled by the temperature of the induction heating coils being applied to the club head assembly 30. Extending the cooling time of the club head assembly 30 may maintain the ductility of the golf club head. Maintaining the ductility while the club head assembly 30 undergoes strengthening and hardening processes prevents the golf club head from becoming too brittle.

As the temperature of the club head assembly 30 has reached just below the Ti₃Al solution temperature and precipitates concentrate along the grain boundaries, the temperature of the induction heating coils is slowly reduced. The temperature of the induction heating coils can slowly decrease in increments until the club head assembly 30 reaching room temperature. In one embodiment, the temperature of the induction coils can decrease in increments of 100° C. every hour. In other embodiments, the temperature of the induction coils can decrease in increments of at most 50° C. every hour, at most 75° C. every hour, at most 100° C. every hour, at most 125° C. every hour, at most 150° C. every hour, at most 175° C. every hour, at most 200° C. every hour, at most 225° C. every hour, at most 250° C. every hour, at most 275° C. every hour, at most 300° C. every hour, at most 325° C. every hour, at most 350° C. every hour, at most 375° C. every hour, or at most 400° C. every hour.

The time span of the club head assembly 30 reaching room temperature by reducing the temperature of the induction coils can range from 1 hour to 8 hours. In some embodiments, the club head assembly 30 can reach room temperature by way of induction heating from 1 hour to 2 hours, from 2 hours to 3 hours, from 3 hours to 4 hours, from 4 hours to 5 hours, from 5 hours to 6 hours, from 6 hours to 7 hours, from 7 hours to 8 hours, from 2 hours to 6 hours, from 4 hours to 8 hours, from 5 hours to 7 hours, or from 3 hours to 8 hours.

Cooling the club head assembly 30 by immersing the club head assembly 30 into a ceramic material “bath” can help extend the cooling time of the golf club head. The bath comprises ceramic beads or chunks that can be heated or cooled by applying a voltage the ceramic materials. Much like the temperature of the induction heating coils, the temperature of the ceramic material bath can be reduced incrementally. Further, much like the induction heating coils, the ceramic material bath may maintain the ductility of the club head assembly 30 by extending the cooling time of the club head assembly 30.

The temperature of the ceramic material bath can slowly decrease in increments until the club head assembly 30 reaching room temperature. In one embodiment, the temperature of the ceramic material bath can decrease in increments of 100° C. every hour. In other embodiments, the temperature of the ceramic material bath can decrease in increments of at most 50° C. every hour, at most 75° C. every hour, at most 100° C. every hour, at most 125° C. every hour, at most 150° C. every hour, at most 175° C. every hour, at most 200° C. every hour, at most 225° C. every hour, at most 250° C. every hour, at most 275° C. every hour, at most 300° C. every hour, at most 325° C. every hour, at most 350° C. every hour, at most 375° C. every hour, or at most 400° C. every hour.

The time span of the club head assembly 30 reaching room temperature by reducing the temperature of the ceramic material bath can range from 1 hour to 8 hours. In some embodiments, the club head assembly 30 can reach room temperature by the ceramic material bath from 1 hour to 2 hours, from 2 hours to 3 hours, from 3 hours to 4 hours, from 4 hours to 5 hours, from 5 hours to 6 hours, from 6 hours to 7 hours, from 7 hours to 8 hours, from 2 hours to 6 hours, from 4 hours to 8 hours, from 5 hours to 7 hours, or from 3 hours to 8 hours.

Convection cooling allows for the entire club head assembly 30 to cool down to room temperature at a relatively slow cooling rate. Convection cooling is done by having a heated material to be cooled down to room temperature by the movement of the surrounding fluids. The surrounding fluid used for convection cooling of the club head assembly 30 can be in an inert gas vacuumed environment chamber or non-contained environment such as open air. The inert gas can be selected from the group consisting of nitrogen, argon, helium, neon, krypton, xenon, or a compound gas thereof. The open air or inert gas extends the cooling time of the club head assembly 30 which reduces the chance for oxidation to occur, and may help further maintain the ductility to prevent the club head assembly 30 from being brittle.

In some embodiments, the club head assembly 30 is subjected to the heat reduction process 400 by reducing the temperature of the induction heating coils slowly to extend the cooling time. In other embodiments, the club head assembly 30 is subjected to the heat reduction process 400 by a ceramic material bath. In other embodiments, the club head assembly 30 is subjected to the heat reduction process 400 by convection cooling. In other embodiments, the club head assembly 30 is subjected to the heat reduction process 400 by any combination of the induction heating, ceramic material bath and convection cooling.

### E) Examples

In one example, a golf club head comprising Ti 6-4 underwent the combined processes of the heat treat process 100, the quenching method process 200, the aging treatment process 300, and the heat reduction process 400. The combined processes further prevent the ductility of the golf club head from dropping too low. After the combined processes, the golf club head was measured to have a yield strength of 160 ksi, a tensile strength of 170 ksi, a percent elongation, which measures ductility, of 10%, and a hardness level of C41 (based on the Rockwell Hardness C Scale). Compared to the a golf club head comprising Ti 6-4 that had been annealed, the combined processes Ti 6-4 had a 25% higher yield strength, a 25.9% higher tensile strength, and a hardness level increase of 6, as shown in Table 1. Further, compared to other golf club heads comprising Ti 6-4 that has undergone other processes of increasing strength, the combined processes prevented the ductility of the golf club head from decreasing to the point of being brittle.

TABLE 1
Durability of Ti 6-4 Golf Club Heads

| | Ti 6-4 Annealed | Ti 6-4 Quenched and Aged |
|---|---|---|
| Yield (ksi) | 128 | 160 |
| Tensile (ksi) | 135 | 170 |
| Elongation (%) | 13 | 10 |
| Hardness (HR) | C35 | C41 |

In another example, a club head assembly 30 comprising Ti 6-6-2 underwent the combined processes of the heat treat process 100, the quenching method process 200, the aging treatment process 300, and the heat reduction process 400. The combined processes further help maintain the ductility of the golf club head from becoming too low. After the combined processes, the club head assembly 30 was measured to have a yield strength of 161 ksi, a tensile strength of 175 ksi, a percent elongation of 8%, and a hardness level of C42, as shown in Table 2. Compared to a golf club head comprising Ti 6-6-2 that had been annealed, the combined processes Ti 6-6-2 had a 13.3% higher yield strength, a 15.1% higher tensile strength, and a hardness level increase of 4. Further, compared to other golf club heads comprising Ti 6-6-2 that had undergone different strength increasing processes, the combined processes maintained the ductility of the golf club head from becoming relatively too low.

TABLE 2
Durability of Ti 6-6-2 Golf Club Heads

| | Ti 6-6-2 Annealed | Ti 6-6-2 Quenched and Aged |
|---|---|---|
| Yield (ksi) | 142 | 161 |
| Tensile (ksi) | 152 | 175 |
| Elongation (%) | 14 | 8 |
| Hardness (HR) | C38 | C42 |

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

As the rules to golf may change from time to time (e.g., new regulations may be adopted or old rules may be eliminated or modified by golf standard organizations and/or governing bodies such as the United States Golf Association (USGA), the Royal and Ancient Golf Club of St. Andrews (R&A), etc.), golf equipment related to the apparatus, methods, and articles of manufacture described herein may be conforming or non-conforming to the rules of golf at any particular time. Accordingly, golf equipment related to the apparatus, methods, and articles of manufacture described herein may be advertised, offered for sale, and/or sold as conforming or non-conforming golf equipment. The apparatus, methods, and articles of manufacture described herein are not limited in this regard.

While the above examples may be described in connection with a driver-type golf club, the apparatus, methods, and articles of manufacture described herein may be applicable to other types of golf club such as a fairway wood-type golf club, a hybrid-type golf club, an iron-type golf club, a wedge-type golf club, or a putter-type golf club. Alternatively, the apparatus, methods, and articles of manufacture described herein may be applicable other type of sports equipment such as a hockey stick, a tennis racket, a fishing pole, a ski pole, etc.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Various features and advantages of the disclosure are set forth in the following claims.

1. A method of a club head assembly, the method comprising:
(a) providing a golf club head having a recess, and providing a faceplate, wherein the golf club head and the faceplate are formed from an α-β Ti alloy, the α-β Ti alloy comprising between 5.5 wt % to 6.75 wt % aluminum (Al), between 3.5 wt % to 4.5 wt % vanadium (V), a maximum of 0.08 wt % carbon (C), a maximum of 0.03 wt % silicon (Si), a maximum of 0.3 wt % iron (Fe), a maximum of 0.2 wt % oxygen (O), a maximum of 0.015 wt % tin (Sn), and a trace of molybdenum (Mo);
(b) aligning the faceplate with the recess of the golf club head;
(c) welding the faceplate to the golf club head;
(d) heat treating the club head assembly to a temperature just below the β-transus temperature of the α-β Ti alloy for a predetermined amount of time;
(e) quenching the club head assembly to room temperature;
(f) aging the club head assembly to a temperature just below the Ti₃Al solution temperature; and
(g) reducing the temperature of the club head assembly to room temperature by increments of at most 400° C. every hour.

2. The method of claim 1, wherein the club head assembly of step (d) is heat treated in an α-β Ti alloy solution between 825° C. and 950° C.

3. The method of claim 1, wherein the quenching of the club head assembly of step (e) comprises fluids selected from the group consisting of straight oils, water, water, water soluble fluid, micro-dispersion oils, and synthetic or semi-synthetic fluids.

4. The method of claim 1, wherein the club head assembly of step (e) is quenched at a quenching rate of at least 550° C. per second.

5. The method of claim 1, wherein the club head assembly of step (f) is aged by induction heat with induction heating coils.

6. The method of claim 1, wherein the temperature of the club head assembly of step (g) is reduced to room temperature in increments of at most 175° C. every hour.

7. The method of claim 1, wherein the temperature of the club head assembly of step (g) is reduced to room temperature in increments of at most 350° C. every hour.

8. The method of claim 1, wherein the temperature of the club head assembly of step (g) is reduced to room temperature in a time span range from 5 hours to 7 hours.

9. The method of claim 1, wherein the temperature of the club head assembly of step (g) is reduced to room temperature in a time span range from 2 hours to 6 hours.

10. The method of claim 1, wherein the temperature of the club head assembly of step (g) is reduced to room temperature in a time span range from 3 hours to 8 hours.

11. A method of a club head assembly, the method comprising:
(a) providing a golf club head having a recess, and providing a faceplate, wherein the golf club head and the faceplate are formed from an α-β Ti alloy, the α-β Ti alloy comprising between 6 wt % Al, 6 wt % V, and 2 wt % Sn;
(b) aligning the faceplate with the recess of the golf club head;
(c) welding the faceplate to the golf club head;
(d) heat treating the club head assembly to a temperature just below the β-transus temperature of the α-β Ti alloy for a predetermined amount of time;
(e) quenching the club head assembly to room temperature
(f) aging the club head assembly to a temperature just below the Ti₃Al solution temperature; and
(g) reducing the temperature of the club head assembly to room temperature by increments of at most 400° C. every hour.

12. The method of claim 11, wherein the club head assembly of step (d) is heat treated in an α-β Ti alloy solution between 400° C. and 630° C.

13. The method of claim 11, wherein the quenching of the club head assembly of step (e) comprises fluids selected from the group consisting of straight oils, water, water, water soluble fluid, micro-dispersion oils, and synthetic or semi-synthetic fluids.

14. The method of claim 11, wherein the club head assembly of step (e) is quenched at a quenching rate of at least 2000° C. per second.

15. The method of claim 11, wherein the club head assembly of step (f) is aged by induction heating with induction heating coils.

16. The method of claim 11, wherein the temperature of the club head assembly of step (g) is reduced to room temperature in increments of at most 125° C. every hour.

17. The method of claim 11, wherein the temperature of the club head assembly of step (g) is reduced to room temperature in increments of at most 275° C. every hour.

18. The method of claim 11, wherein the temperature of the club head assembly of step (g) is reduced to room temperature in a time span range from 5 hours to 7 hours.

19. The method of claim 11, wherein the temperature of the club head assembly of step (g) is reduced to room temperature in a time span range from 7 hours to 8 hours.

20. The method of claim 11, wherein the temperature of the club head assembly of step (g) is reduced to room temperature in a time span range from 3 hours to 8 hours.
